(19) United States
(12) Patent Application Publication
(10) Pub. No.: US 2010/0257023 A1
(43) Pub. Date: Oct. 7, 2010

(54) Leveraging Information in a Social Network for Inferential Targeting of Advertisements

(75) Inventors: Timothy Kendall, Palo Alto, CA (US); Ding Zhou, Palo Alto, CA (US)

Correspondence Address: FENWICK & WEST LLP, SILICON VALLEY CENTER, 801 CALIFORNIA STREET, MOUNTAIN VIEW, CA, 94041, US

(73) Assignee: FACEBOOK, INC., Palo Alto, CA (US)

(21) Appl. No.: 12/419,958

(22) Filed: Apr. 7, 2009

(51) Int. Cl. G06Q 30/00; G06Q 10/00; G06Q 99/00

(52) U.S. Cl. 705/10; 705/14.1; 705/319

(57) ABSTRACT

A social network targets advertisements to its members using inferential ad targeting. An inferential ad enables advertisers to reach members that do not meet targeting criteria for lack of information. A member's connections in the social network that satisfy the targeting criteria are leveraged to infer a targeted interest. An inferential ad is selected from a candidate set to be presented to the member. Varying complexities of targeting criteria, secondary inferential targeting criteria, and scopes of inference provide flexibility for inferential ad targeting in a social network.

### BACKGROUND

This invention relates generally to social networking and, in particular, to targeting advertising to users of a social network.

Social networks, or social utilities that track and enable connections between members (including people, businesses, and other entities), have become prevalent in recent years. In particular, social networking websites allow members to communicate more efficiently information that is relevant to their friends or other connections in the social network. Social networks typically incorporate a system for maintaining connections among members in the social network and links to content that is likely to be relevant to the members. Social networks also collect and maintain information about the members of the social network. This information may be static, such as geographic location, employer, job type, age, music preferences, interests, and a variety of other attributes, or it may be dynamic, such as tracking a member's actions within the social network. This information about the members can then be used to target information delivery so that information more likely to be of particular interest to a member can be communicated to that member.

Advertisers have attempted to leverage this information about members of social networks to target ads to members whose interests align with the ads. For example, a social networking website may display a banner ad for a concert to members who have listed an interest for the performing band on their member profile and live near the concert venue. One drawback of this type of ad targeting, however, is that it relies on the information provided by or otherwise obtained about members of the social network. Members of social networks often do not populate their profiles to include all of their interests and other personal information. As a result, using personal information in ad targeting is typically not available for all members of the social network. Traditional ad targeting techniques are thus limited because they can reach only a subset of the members in the social network for whom the ads are intended.

### SUMMARY

To optimize the targeting and selection of ads for members of a social network, embodiments of the invention leverage information in the social network to infer interests about members of the social network. A social network may maintain a social graph that identifies the mapping of connections among the members of a social network, and the social network may also maintain profiles that contain full or partial information about each of the members in the social network. One or more advertisements, or ads, available to the social network may contain targeting criteria for determining whether the ad should be targeted to a particular member. While the social network may have sufficient information about some of its members to apply the targeting criteria, the social network may not have sufficient information about other members to apply the targeting criteria. Rather than missing out on the opportunity to target ads to this latter group of members, embodiments of the invention use the information for other members to whom a particular member is connected when the social network does not have sufficient information to apply the targeting criteria to the member. This may be thought of as “inferential” ad targeting because a member's likely interest in a particular ad is inferred based on whether that member's connections (e.g., friends in the social network) are good candidates for the ad based on its targeting criteria.

Embodiments of the invention may employ various targeting criteria and methods of leveraging information in the social network to infer a member's interests based on an advertiser's campaign strategy. A simple ad targeting strategy may use targeting criteria for an ad that evaluates a particular parameter or field in a member's profile. More complex strategies may include targeting criteria that evaluates a function of the member's actions on the social network, such as the member's browsing habits. Additionally, information in the social network may be leveraged in many different ways to infer the interests of a member. Moreover, embodiments of the invention may apply the same targeting criteria to a member's connections that were applied to the member's profile that lacked information, or different criteria may be evaluated when looking to the member's connections. For example, to account for the lower level of certainly when the targeting is inferred, stricter targeting criteria may be applied to the member's connections than the targeting criteria applied to the member's profile.

Ads that have targeting criteria to be applied to a member's connections in the social network, in embodiments of the invention, may be referred to as “inferential” ads. Inferential ads may differ in the scope of inference by varying the quantity and quality of connections included in the ad targeting process. For example, secondary inferential targeting criteria may include all of the member's connections in an attempt to infer an interest for the member, or an ad may focus on a smaller subset of the member's connections. The smaller subset of member's connections may be selected because of the member's affinity for those members, or because the smaller subset share a characteristic that the advertiser wishes to target, such as being alumni of the same college. The quality or affinity associated with connections also may be varied to include multiple tiers of connections. An inferential ad may include only the member's direct connections or may include indirect connections, or the direct connections of the member's connections.

Inferential ads may also include the ability to set thresholds for targeting criteria as applied to a member's connections. For example, an advertiser may determine that an ad may infer an interest for a member if more than 25% of the member's connections satisfy the secondary inferential targeting criteria or if at least 3 connections meet the main targeting criteria, or a combination of both. The ad targeting method may also weight the member's connections or otherwise take into account the member's affinity or other measure of closeness to the member's connections. Any combination of the above methods may be implemented in the ad targeting method.

In one embodiment, the ad targeting techniques are used to determine a candidate set of ads for a member, and one or more of the ads are selected according to the revenue they are expected to generate. In another embodiment, ads are selected according to the member's affinities for the connections or another measure of the closeness of the member to the connections whose interests are inferred. In yet another embodiment, the method learns over time the affinities and interests of a member presented with inferential ads in response to their feedback. In an alternative embodiment of inferential ad targeting may be implemented regardless of whether the member's profile lacks information to satisfy targeting criteria. In other alternative embodiments, various combinations of the above inferential ad targeting techniques are implemented.

### BRIEF DESCRIPTION OF THE DRAWINGS

FIG. 1 is a diagram illustrating a process for inferential ad targeting to a member of a social network based on the member's connections, in accordance with an embodiment of the invention.

FIGS. 2A-B are diagrams of a system for targeting ads to members of a social network, in accordance with an embodiment of the invention.

FIG. 3 is an interaction diagram of a process for advertising to a member by leveraging information about the member's connections in the social network, in accordance with an embodiment of the invention.

FIGS. 4A-D are flowcharts of various methods for selecting ads to present to the member, in accordance with embodiments of the invention.

FIG. 5 is a flowchart of a process for improving the targeting of ads to a member based on feedback from the member, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Inferential Ad Targeting in a Social Network

A social networking website offers its members the ability to communicate and interact with other members of the social network. In use, members join the social network and then add connections to a number of other members to whom they desire to be connected. As used herein, the term “friend” refers to any other member to whom a member has formed a connection, association, or relationship via the website. Connections may be added explicitly by a member, for example, the member selecting a particular other member to be a friend, or automatically created by the social networking site based on common characteristics of the members (e.g., members who are alumni of the same educational institution). Connections in social networks are usually in both directions, but need not be, so the terms “member” and “friend” depend on the frame of reference. For example, if Bob and Joe are both members and connected to each other in the website, Bob and Joe, both members, are also each other's friends. The connection between members may be a direct connection; however, some embodiments of a social networking website allow the connection to be indirect via one or more levels of connections. Also, the term friend need not require that members actually be friends in real life, (which would generally be the case when one of the members is a business or other entity); it simply implies a connection in the social network.

In addition to interactions with other members, the social networking website provides members with the ability to take actions on various types of items supported by the website. These items may include groups or networks (where “networks” here refer not to physical communication networks, but rather social networks of people) to which members of the website may belong, events or calendar entries in which a member might be interested, computer-based applications that a member may use via the website, and transactions that allow members to buy or sell items via the website. These are just a few examples of the items upon which a member may act on a social networking website, and many others are possible.

Advertisements on a social network attempt to leverage information a social network in order to reach a specific audience whose interests align with ads. To do so, advertisers employ targeting criteria for their ads to members of a social network. It is well known to use certain demographic data to target audiences for certain advertisements. For example, a pop music promoter for Britney might want to target advertisements towards certain age and gender demographics.

Advertisers on a social network may also target their advertisements to members who have listed particular interests on their member profiles. Each member has a profile in which he or she can list interests. For example, a classical music aficionado might list “Chopin” or “Bach” as interest. Advertisers may, in turn, target their ads towards members who have listed “Chopin” as an interest. A simple word match comparison would select ads to be presented to these members.

This approach is problematic, however, because interests are self-reported by members. Many members who have a genuine interest in Chopin might not have explicitly listed Chopin as an interest in their profiles on a social network. As a result, an advertiser may miss out on members who have “incomplete” profiles—incomplete only in the sense that the profiles lack the information that the ad's targeting criteria is testing. Thus, the advertiser's reach is significantly reduced.

To counter this problem, a social network enables advertisers to extend the reach of their advertisements by leveraging information in the social network about a member with an incomplete profile. An advertisement may have targeting criteria that, for example, tests whether a member has listed “Britney” as an interest. Targeting criteria can be defined as a test or series of tests that can apply to a particular field in a member's profile. Traditionally, the interest field of a profile must list “Britney” in order for the ad to be presented to the member. However, embodiments of this invention enable advertisers to reach a broader base of members who may not have actually listed a targeted interest of the ad. This advertising technique infers a targeted interest for a member based on the interests listed on profiles of the member's connections.

“Inferential” ad targeting on a social network allows advertisers to reach members whose profiles fail to satisfy an ad's targeting criteria. For example, many members on a social network may not have listed Britney as an interest on their member profiles despite an actual interest in Britney. Advertisers may extend the reach of their advertisements to these members if the members' friends, or connections, actually list an interest in Britney on their profiles. Giving credence to the old adage “guilt by association,” the social network may, in one embodiment, infer an interest in Britney even though the member has not explicitly listed that particular interest in his or her profile. An “inferential ad” thus refers to an ad that allows targeting criteria to be satisfied by applying targeting criteria to the member's connections in the social network.

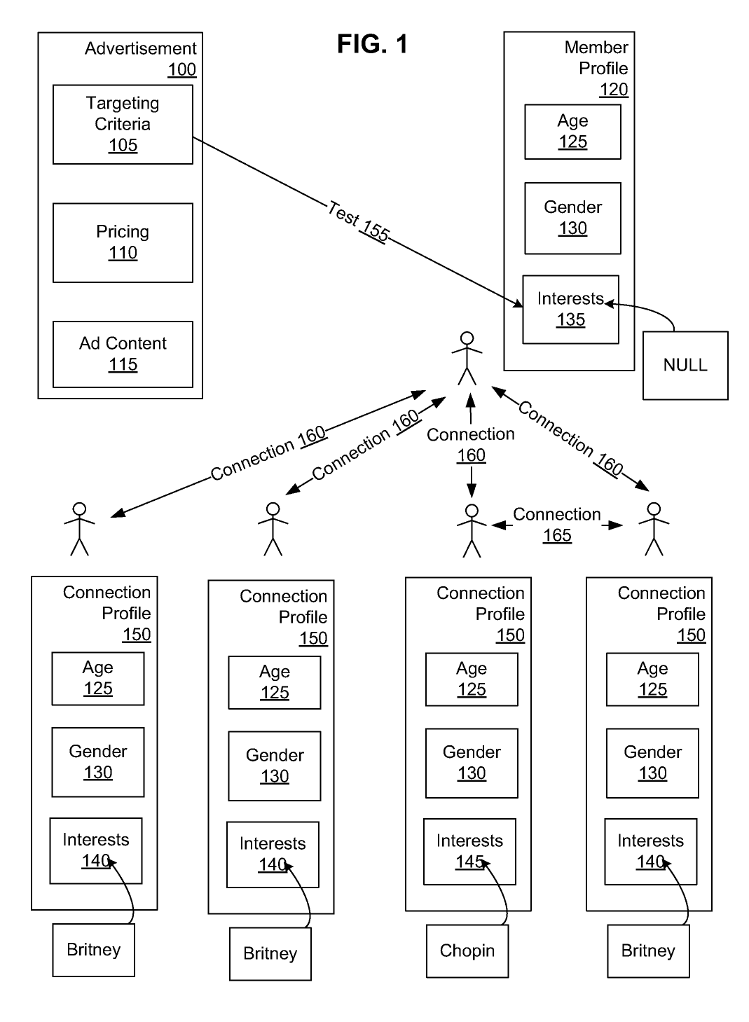

FIG. 1 depicts a diagram illustrating a process for inferential ad targeting to a member of a social network based on the member's connections. An advertiser on a social network generates an advertisement 100 that comprises, among other things, targeting criteria 105, pricing 110, and ad content 115. Targeting criteria 105 may include multiple tests, such as a test for a certain demographic, a test for certain actions which the member may have performed on the social network, or any other information accessible from the member's profile 120. In FIG. 1, the targeting criteria 105 comprises of a test 155 for an interest 140 in Britney as listed in a member profile 120. The test 155 is the “main” targeting criteria and comprises a simple evaluation of a field in a member's profile, whether the field has included the word “Britney.” In this example, the member profile 120 has a “NULL” value for interests 135. This means that the member did not list “Britney” as an interest.

As illustrated in FIG. 1, it is determined whether the member has connections 160 that have connection profiles 150 that include the interest being targeted in the test 155. For example, three of the four connections 160 have connection profiles 150 that include an interest 140 in Britney. The targeting criteria 105 includes “secondary” inferential targeting criteria to determine whether to infer an interest 140 in Britney for the member profile 120 on the basis that three of four connections 160 have explicitly listed an interest 140 in Britney. Various methods of targeting criteria and scope of inference may be utilized as discussed in detail below. In this example, the secondary inferential targeting criteria is that at least one of the member's connections listed an interest 140 in Britney.

FIG. 1 shows that, in addition to interests, a member profile 120 and connection profiles 150 include demographic data such as age 125 and gender 130. Other demographic data not illustrated may include schools which the member or connection attended, networks based on location, and networks based on workplaces. Other groupings are also known to persons having ordinary skill in the art. FIG. 1 also illustrates that profiles include listed interests 135, 140, and 145. A profile with no listed interests 135 may mean that the profile is either empty or the profile has not listed the type of information being tested by the targeting criteria 105 of an advertisement 100. In another embodiment, if a member only listed an interest 145 in Chopin and targeting criteria 105 were testing for an interest 140 in Britney, it could be determined that the member has a connection 165 that list an interest 140 in Britney, as shown in FIG. 1. This is because the targeting criteria 105, in this example, is simply searching for at least one of the member's connections that list an interest 140 in Britney. Targeting Criteria and Scope of Inference

The inferential ad targeting technique described above can be varied by advertisers according to the purposes of the advertising campaign. The targeting criteria of an inferential ad may be vary in complexity, may include secondary inferential targeting criteria to determine whether an ad should be included in a candidate set for a member, and also may include a threshold technique utilizing secondary inferential targeting criteria. The scope of inference can also be varied to include different numbers of connections, qualitatively distinct connections, and may include weighting connections by the member's affinity or another measure of closeness on the social network. Any combination of these techniques may be implemented by an advertiser to better refine the targeting criteria and scope of inference tailored to the needs of the advertising campaign.

An advertiser may implement targeting criteria for ads that vary in degrees of complexity. For example, an advertiser may simply target members that list certain keywords in their profiles, such as “canoeing.” More complex targeting may evaluate a function of a member's actions on the social network, such as, for example, identifying members who regularly click on videos posted by other members. The social network may identify behavioral characteristics of members on the social network and enable advertisers to target these characteristics.

Targeting criteria, in one embodiment, may also comprise “main” targeting criteria and “secondary” inferential targeting criteria. The main targeting criteria of an ad targets members of a social network and evaluates information on their profiles. Thus, the main targeting criteria of “canoeing” is satisfied if a member lists canoeing as an interest. Secondary inferential targeting criteria is used to determine if an ad should be presented to a member even though the member fails to satisfy the main targeting criteria. Secondary inferential targeting criteria is applied to the member's connections and may be the same as the main targeting criteria, or may differ to take into account the uncertainty of whether the member is actually interested in “canoeing,” as an example.

Secondary inferential targeting criteria may be as complex or as simple as desired. For example, suppose an advertiser implements complex targeting criteria that evaluates a member's proclivity to click on videos posted by a small subset of connections because the ad features a video. If the “main” targeting criteria establish a certain threshold for the measure of a member's proclivity to click on videos, a member may not meet that threshold. Additionally, a member may be new to the social network and, therefore, would not have the particular information being targeted. Secondary inferential targeting criteria may evaluate whether a certain threshold percentage of the member's connections meet the “main” criteria, or it may evaluate different criteria altogether, such as determining whether the member's connections have posted videos. The advertiser has tremendous flexibility in establishing targeting criteria in this respect.

Inferential ads may also differ in the scope of inference by varying the quantity and quality of connections included in the ad targeting process. For example, secondary inferential targeting criteria may include all of the member's connections in an attempt to infer an interest for the member, or an ad may focus on a smaller subset of the member's connections. The smaller subset of member's connections may be selected because of the member's affinity for those members, or because the smaller subset share a characteristic that the advertiser wishes to target, such as being alumni of the same college.

The quality of connections also may be varied to include multiple tiers of connections. An inferential ad may include only the member's direct connections or may include indirect connections, or the direct connections of the member's connections. For example, an advertiser may wish to target all alumni of specific colleges, in addition to other targeting criteria. A member who satisfies all of the other targeting criteria, but fails to list himself as an alum of one of the targeted colleges, would fail to satisfy the “main” targeting criteria. However, the targeting criteria may include secondary inferential targeting criteria to only evaluate the number of connections that have listed themselves as alums of the targeted colleges. The quality of connections can also be specified by the advertiser, meaning that indirect connections may also be included in the evaluation of the secondary inferential targeting criteria. Thus, if the secondary inferential targeting criteria, as defined by the advertiser, is satisfied, the member would be presented with the ad.

As already mentioned above, inferential ads may also include the ability to set thresholds for targeting criteria as applied to a member's connections. For example, an advertiser may determine that an ad may infer an interest for a member if more than 25% of the member's connections satisfy the secondary inferential targeting criteria or if at least 3 connections meet the main targeting criteria, or a combination of both. The ability to set thresholds for different types of targeting criteria contributes to the flexibility and refinement capabilities of embodiments of the invention.

The ad targeting algorithm may also weight the member's connections or otherwise take into account the member's affinity or other measure of closeness to the member's connections. In one embodiment, an expected click-through rate (ECTR) may be computed based on the affinity between the member and the connection. Measuring the affinity between members of a social network is well-known to those having ordinary skill in the art. An affinity score may also be called a coefficient of correlation because an affinity score indicates the strength of correlation between the member and a connection in the social network. Based on the interactions between the member and the connection, an affinity score is unidirectional, meaning that a member may have a high affinity for a connection but the same connection may have a low affinity for the member. Methods for determining affinities between members of a social network are described further in U.S. application Ser. No. 11/503,093, filed Aug. 11, 2006, entitled “Displaying Content Based on Measured User Affinity in a Social Network Environment,” hereby incorporated by reference in its entirety.

Any combination of the above targeting methods and ways of determining the scope of inference may be implemented in the ad targeting algorithm. In one embodiment, the advertiser has the ability to enable or disable the above features.

### Website Architecture and Interaction

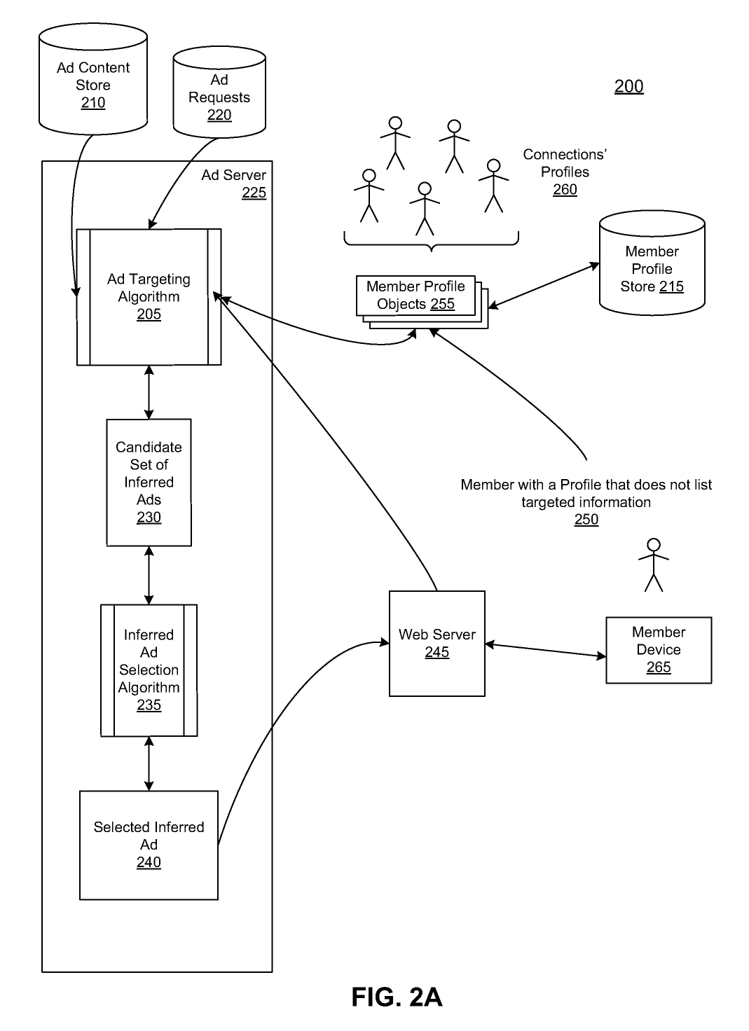

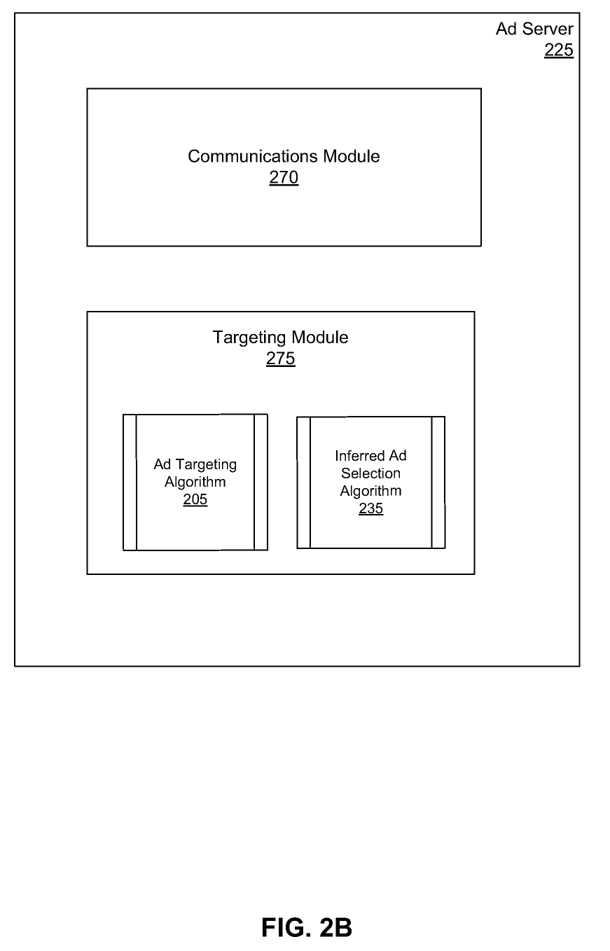

FIG. 2A depicts a high level block diagram of the system architecture in one embodiment. In the social network 200, an ad targeting algorithm 205 executes on an ad server 225. The ad targeting algorithm 205 receives ad requests from an ad requests store 220. Ad content is stored in an ad content store 210. Each member of the social network is associated with a member profile object 255 that is stored in a member profile store 215. The member profile store 215 maintains member profile objects 255 that each contain profile information about members of the social network. Profile information, in one embodiment, may include static information, i.e., interests such as canoeing and Chopin that is listed on a profile in the social network, and/or dynamic information such as the actions a member has taken in the social network and the actions taken in related to a member in the social network. Alternatively, the dynamic information for multiple members may be stored centrally by the social network, such as in an action log (in the case where the dynamic information includes actions taken by members within or even outside the social network). In other embodiments, the dynamic information may be computed on the fly (e.g., such as an affinity between a member and another member or another object in the social network, which can change over time).

A web server 245 receives a request for a web page from a member device 265 as a member accesses the social network 200. The web server 245 requests an ad for the member from the ad server 225, specifically the ad targeting algorithm 205.

As shown in FIG. 2A, the ad targeting algorithm 205 accesses member profile objects 255 to determine whether a member's profile meets the targeting criteria 105 of an ad 100. In FIG. 2A, a member 250 may have a profile that does not list the targeted information in the member's profile 255. Thus, the ad targeting algorithm 205 will retrieve, as member profile objects 255, the profiles of connections 260 of a member 250 whose profile does not list the information being targeted.

The ad targeting algorithm 205 narrows the ad requests into a candidate set of inferred ads 230 using the information from the connections' profiles 260. The candidate ads 230 have targeting criteria 105 that matches the interests listed in the connections' profiles 260. An inferred ad selection algorithm 235 chooses one of the candidate ads 230 for presentation to the member whose profile does not list the information 250 being targeted. The selected inferred ad 240 is then sent to the web server 245 for presentation to the member device 265. In this way, an advertiser has extended the reach of an advertisement to a member who may not have been targeted because the social network lacked the information being evaluated for the member. In effect, the social network “fills the gap” by making an inference based on the profiles of the member's connections.

FIG. 2B depicts a high level block diagram of an ad server 225. The ad server 225 comprises a communications module 270 and a targeting module 275. In one embodiment, the targeting module 275 comprises the ad targeting algorithm 205 and the inferred ad selection algorithm 235.

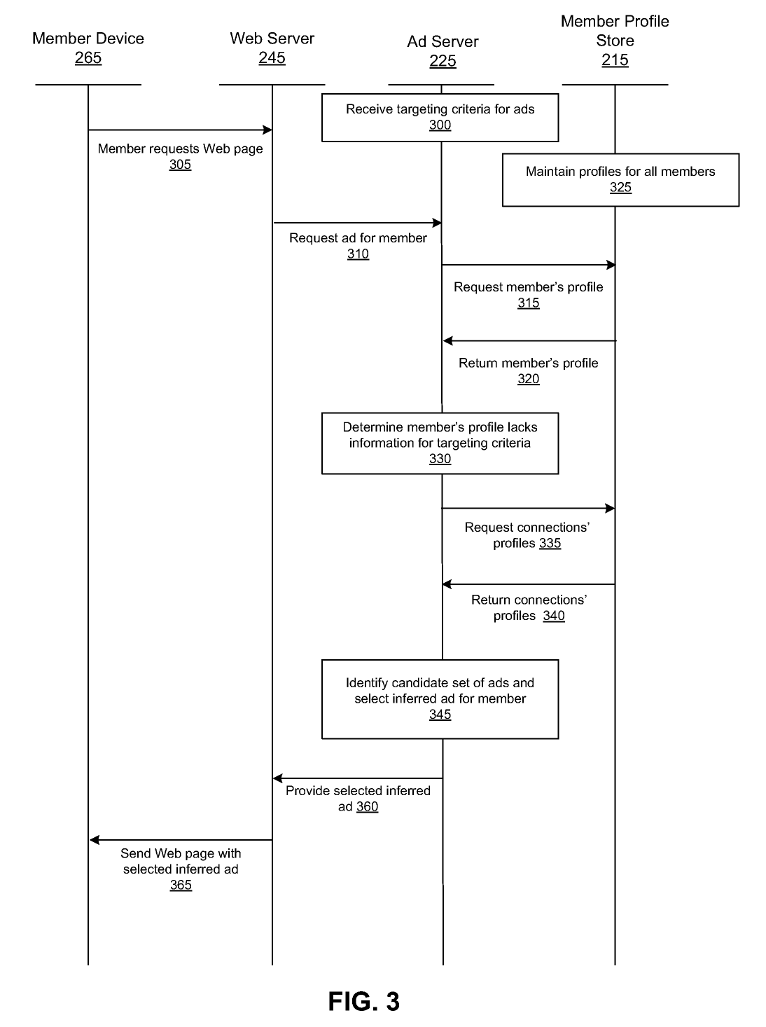

In FIG. 3, an interaction diagram shows the data flow within the system architecture, in one embodiment. An ad server 225 receives 300 targeting criteria for ads. A member device 265 sends a request 305 for a web page. The web server 245, in response to the request, sends an ad request 310 for the member. The ad server 225, in response to receiving the ad request 310, requests the member's profile 315 from the member profile store 215. The member profile store 215 returns the member's profile 320 to the ad server 225. The ad server then determines that the member's profile lacks the information being targeted 330.

After this determination 330, the ad server 225 requests the member's connections' profiles 335 from the member profile store 215. The member profile store 215 returns the connections' profiles 340. Using the interests listed by the connections' profiles, the ad server 225 identifies a candidate set of ads and applies an algorithm to select an inferred ad for the member 345. The selected inferred ad is provided 360 to the web server 245. Finally, the web server 245 sends a web page comprising the selected inferred ad 365 to the member device 265.

### Selection of Inferential Ads for a Member

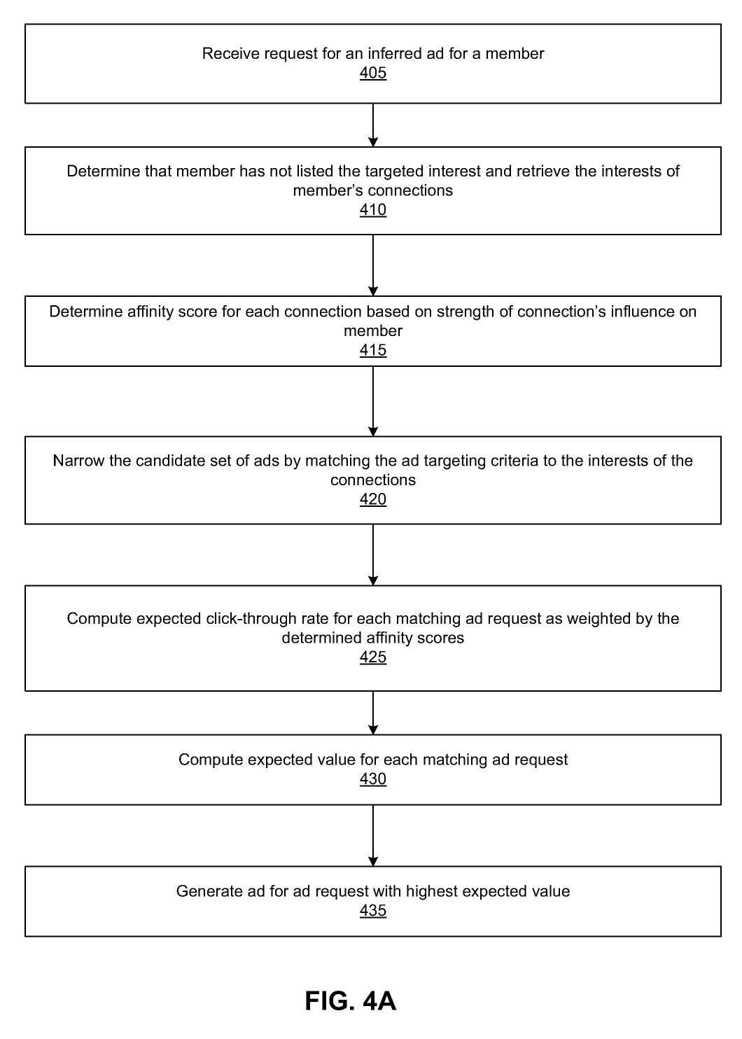

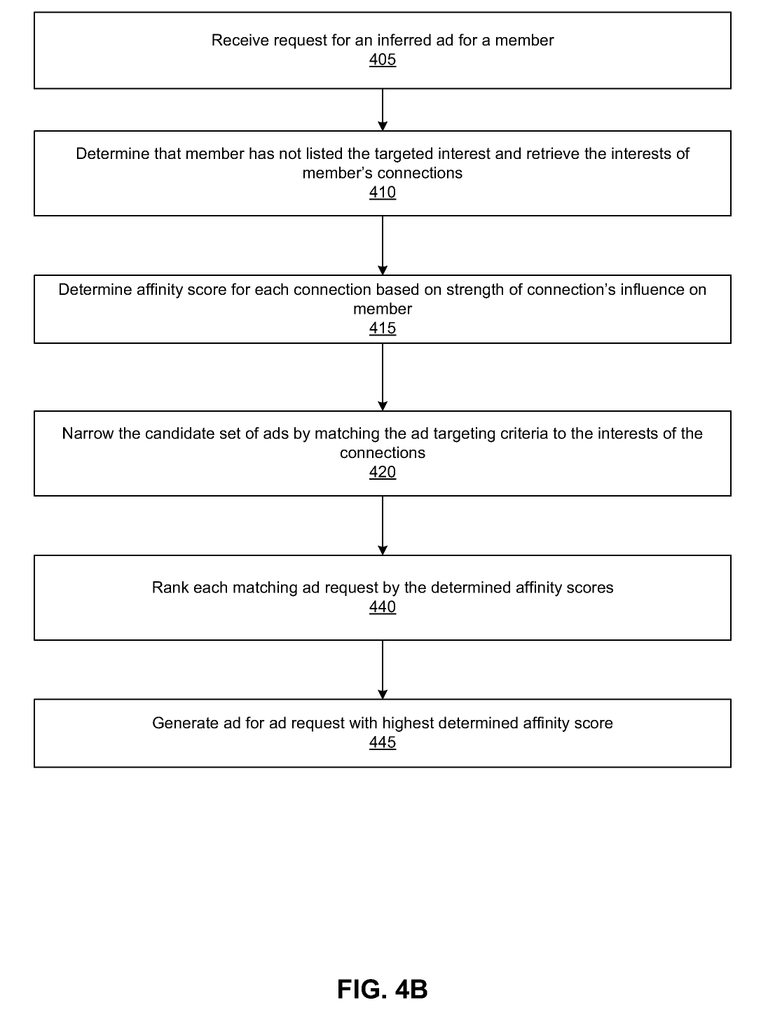

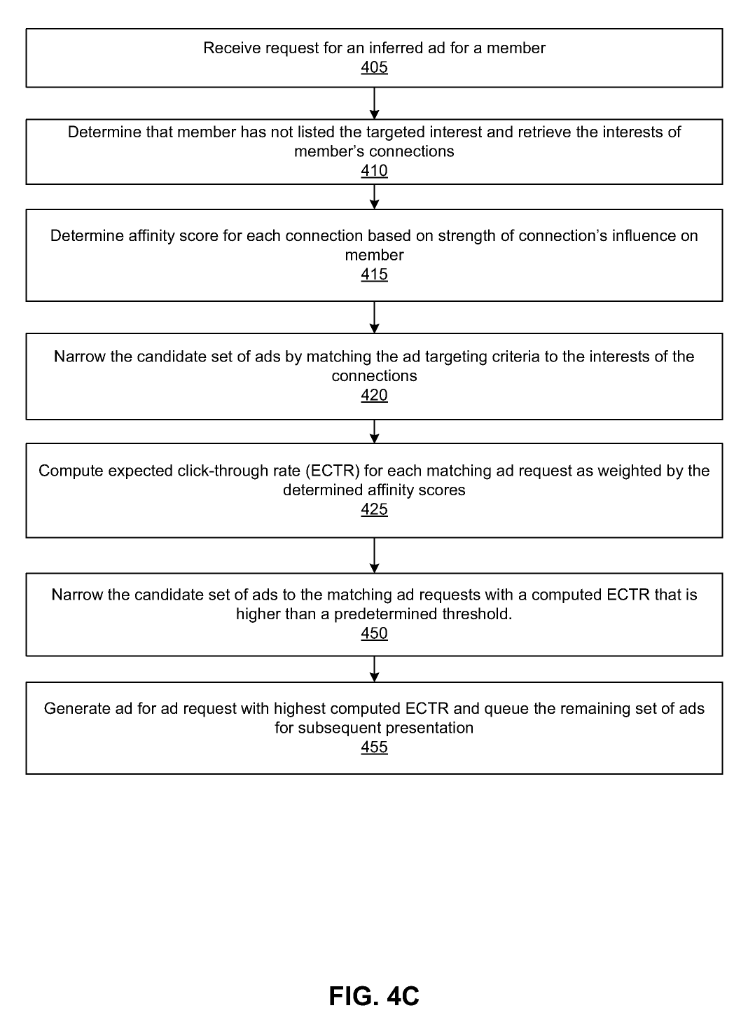

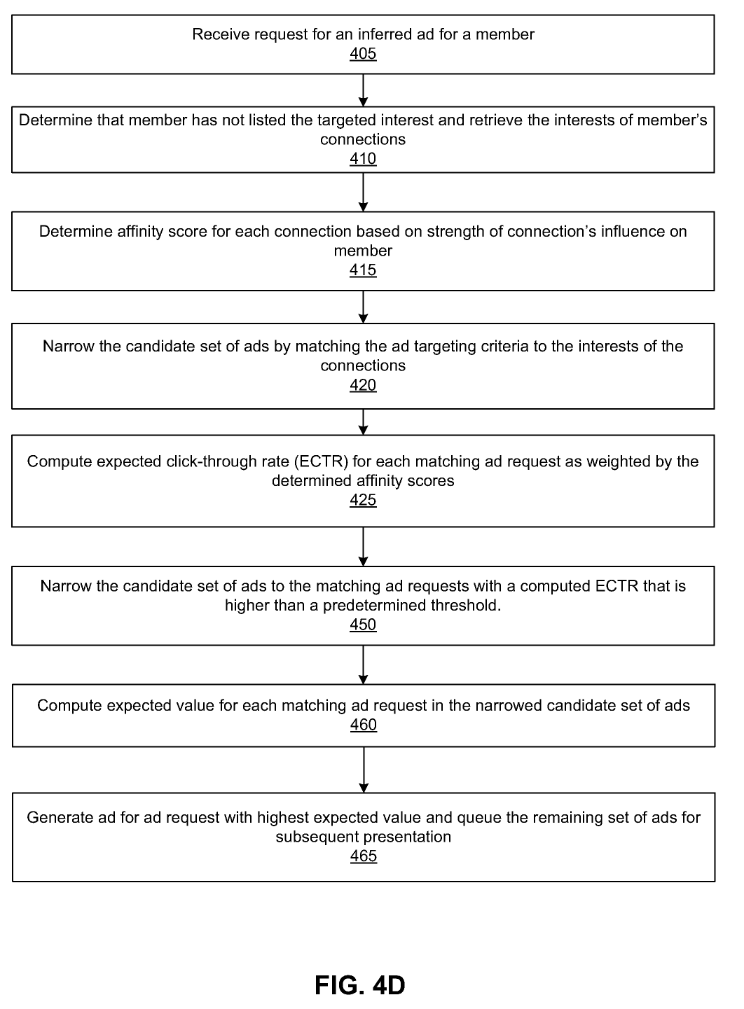

FIGS. 4A-D illustrate various methods of selecting an inferred ad for a member whose profile lacks information targeted by advertisers in various embodiments. In FIGS. 4A-D, a request for an inferred ad for a member is received 405. Once it is determined 410 that the member's profile has not listed the targeted interest of the inferred ad, the interests of the member's connections are retrieved 410. An affinity score is determined 415 for each retrieved connection. Each affinity score, as discussed above, is based on the strength of the connection's correlation with the member. The candidate set of available ads is narrowed 420 by matching the ad targeting criteria of the ads to the interests listed by the connections of the member. In this way, the targeting criteria of the candidate set of ads are satisfied for the member by inferring the interests of the member's connections. These steps have already been described in detail above.

At this point, each ad within the candidate set of ads is an inferred ad, meaning that an inference has been made to infer an interest for a member that did not explicitly list the inferred interest in the member's profile. However, there are multiple methods of selecting an inferred ad for a member. Each method serves different purposes suitable for various types of advertisers, large and small. By leveraging information in the social network, inferential ad targeting enables advertisers to select the most appropriate inferred ad for the advertising campaign.

In FIG. 4A, the next step comprises computing 425 an expected click-through rate (ECTR) between the member and each matching ad request as weighted by the determined affinity scores. The ECTR is a “best guess” at how likely a member might click on the ad based on the number of connections listing the interest and the affinity scores between each connection and the member. For example, if a member who did not explicitly list an interest in Britney but had 20 connections who had listed Britney as an interest in their profiles, the ECTR would be higher than if the member only had 1 connection with the targeted interest. Additionally, the ECTR is weighted by the affinity scores of the connections that list the targeted interest. That is, if a member had high affinity scores with 5 connections that each lists an interest in Chopin but had lower affinity scores with 5 connections that each list Britney as an interest, the ECTR for Chopin would be higher than the ECTR for Britney.

FIG. 4A further depicts computing 430 an expected value for each matching ad request. The expected value of each ad may be calculated using well-known algorithms, such as those described in U.S. application Ser. No. 12/193,702, filed Aug. 18, 2008, entitled “Social Advertisements and Other Informational Messages, and Advertising Model for Same,” hereby incorporated by reference in its entirely. The expected click through rate may be lower for inferred targeted members in order to account for a potential lower likelihood of clicks. For example, a promoter might want to advertise the launch of a new Britney album by targeting members who listed Britney as an interest in their profile. In an effort to extend the reach of the advertisement, the promoter might also enable the advertisements to reach inferred targeted members. The expected click through rate of the advertisement would be lower on the whole because of the inferred targeted members, but the volume of clicks would likely increase because the advertisement would have an extended reach to a broader audience. Finally, the ad with the highest expected value of the candidate set of inferred ads would be generated 435 for the inferred targeted member. In this way, the selection of the inferred ad is optimized to maximize the expected value by leveraging the social graph.

FIG. 4B illustrates a different inferred ad selection method after narrowing 420 the candidate set of ads to those ads with targeting criteria that match the interests of connections. The matching ad requests are ranked 440 by the determined affinity scores. If multiple connections list the same interest, in one embodiment, the affinity scores of the connections are averaged. The ad request with the highest determined affinity score is generated 445 for the member. Thus, in this embodiment, the ad that the member is most likely to click on, without regard to the expected value of the ad, is generated.

FIG. 4C illustrates an alternative embodiment in which, after an ECTR is computed 425, the candidate set of inferred ads is narrowed 450 to ads with a computed ECTR that is higher than a predetermined threshold. The ad with the highest computed ECTR is then generated 455 for the member and the remaining set of inferred ads are queued for subsequent presentation. This method of inferred ad selection ensures that the inferred ads presented to the member satisfy a certain threshold of interest, thus optimizing the experience of inferred targeted members. For example, if Blockbuster wanted to buy 100,000 brand impressions for members who list an interest in horror movies and 75,000 members actually listed an interest in horror movies, the remaining 25,000 brand impressions would be filled with inferred targeted members who met a certain threshold of inferred interest. This would increase the likelihood that the 25,000 inferred targeted members would click on the advertisement because those 25,000 inferred targeted members had an ECTR that exceeded a predetermined threshold value, in one embodiment of the invention. An advertiser might choose this selection method if the advertiser were more concerned about performance advertising rather than brand advertising.

FIG. 4D shows an alternative embodiment of inferred ad selection. After computing 425 an ECTR between the member and each matching ad request as weighted by the determined affinity scores, the candidate set of inferred ads are narrowed 450 to those ad requests with a computed inferred interest core that is higher than a predetermined threshold. Next, the expected value for each matching ad request in the narrowed candidate set of inferred ads is computed 460. Finally, the ad with the highest expected value is generated 465 for the member and the remaining ads are queued for subsequent presentation. Similar to the method presented in FIG. 4C, the method presented in FIG. 4D accounts for the highest expected value of the narrowed candidate set of inferred ads and queues the remaining ads for subsequent presentation.

Any number of variations and modifications can be made to the methods described above in selecting an ad for a member that are not illustrated herein. The social network is able to accommodate different types of advertising campaign objectives, including maximizing revenue and maximizing the user experience. Complex algorithms and customizations can be implemented to the above methods to achieve these objectives.

Learning Affinities Based on User Feedback from Inferential Ads

As described above, affinities between a member and the member's connections play an integral role in inferential ad targeting and selection. Improving and identifying erroneous affinities helps the social network provide better information to advertisers targeting audiences based on their interests, inferred or otherwise. In addition, the user experience is increased by identifying erroneous affinities because ads for items that actually interest the member are provided. Based on user feedback, affinities may be adjusted and incorporated into subsequent inferred ads. Likewise, if a member clicks on an inferred ad, that inferred ad may be queued for presentation to the member's connections as a result.

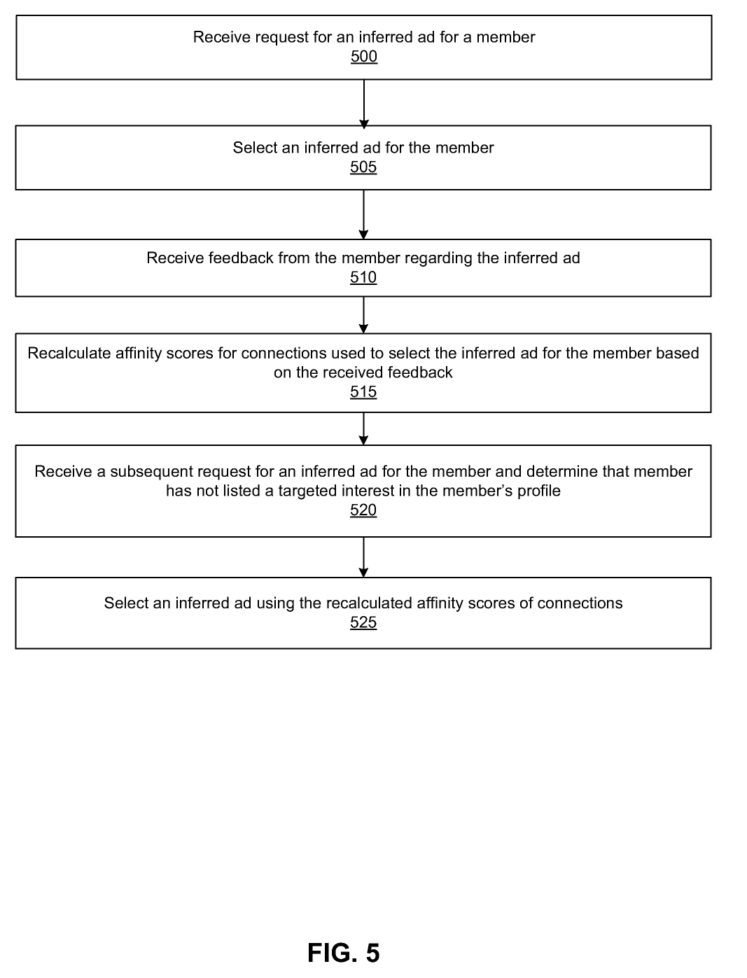

FIG. 5 illustrates one embodiment of learning affinities for inferential ad targeting. After a request for an inferred ad is received 500 for a member and an inferred ad is selected 505 for the member, feedback is received 510 from the member regarding the inferred ad. The feedback may be direct or indirect. Direct feedback would include feedback from the member that is an active judgment of the advertisement, the member expressing approval or disapproval of the advertisement. However, most feedback is indirect, meaning that the member either clicked on a link within the advertisement or ignored the ad completely.

Using the member's feedback, affinity scores are recalculated 515 for the connections relied upon to select the inferred ad. Affinity scores would increase or decrease based on the feedback provided by the member. When a subsequent request for an inferred ad is received 520 for the member, the recalculated affinity scores will be used in selecting 525 an inferred ad for the member. The selection of the ad may comprise of any of the methods mentioned above, but would incorporated the recalculated, or “learned,” affinity scores of connections previously relied upon for inferential ad targeting.

### Object-Based Inferential Ad Targeting

Thus far, inferential ad targeting for a member has been described in terms of a lack of information listed on the member's profile, focusing on simple targeting criteria such as evaluations of fields in the member's profile and in the profiles of the member's connections. However, inferential ad targeting includes more complex targeting criteria based on member profile objects. Targeting criteria may include a test for anything that is targetable on a member profile object. A member profile object on a social network comprises basic demographic data and interests listed by the member, but also includes types of objects which the member interacts with frequently, such as polls, events, groups, pages, applications, links, notes, advertisements, photos, videos, status updates, as well as network information based on geographic location, school and college alumni status, and current and former employers.

For example, if a photo sharing service would like to advertise to members who tend to create and share photo albums, an advertisement could be targeted for member profiles exhibiting that behavioral characteristic. However, if a member has not created or shared photo albums, the advertiser may want to reach that member even though the member's profile object does not exhibit the targeted behavioral characteristic. Applying the inferential ad targeting technique described above, the member's connections' profile objects would be retrieved to infer the targeted characteristic. As a result, a targetable behavioral characteristic of a member's profile can be defined as anything existing on a member's profile upon which a test can be applied. If a test cannot be applied to a member for lack of information, the test can be applied to the member's connections to infer the missing information, in this case a behavioral characteristic, for the member.

Additionally, a member profile object may include information about the types of advertisers and advertisements that have been successful in advertising to the member. For example, if a member clicks on advertisements related to new cars, the behavioral data would be targetable via the member's profile object. If a member lacks that behavior characteristic, the member's connections' profile objects can be retrieved to infer the behavioral characteristic in the method described above. Also, metadata about the various types of advertisements on the social network, including social ads, interactive ads, banner ads, and fan pages, which have been successful in engaging member, are targetable via the member's profile object. For example, suppose a member has enjoyed watching video commercials and then commenting on the commercials within the social network. That behavior characteristic can be targeted by advertisers and can also be inferred using the inferential ad targeting technique described above. Countless behavioral characteristics may be targeted via member profile objects, and in turn, can also be inferred by the behavioral characteristics exhibited by the member's connections in a social network. Thus, behavioral characteristics exhibited by members are also targetable interests on member profiles.

Furthermore, inferential ad targeting may be implemented regardless of whether information is lacking in a member's profile. For example, if a member has an interest in surfing and has listed that interest on his profile, an ad with simple targeting criteria, such as a word matching algorithm, would be satisfied. However, more refined ad targeting criteria may be implemented using inferential ad targeting. Suppose that an advertiser wants to market surfboard products to a more serious surfer. Using the inferential ad targeting techniques described above, an advertiser would have more options to create more sophisticated targeting criteria. Such an advertiser may require that the member list the interest in surfing and be connected to 5 other members who also list an interest in surfing for the targeting criteria to be satisfied. Thus, the advertiser is able to target members with a more “extreme” interest using inferential ad targeting techniques.

Inferential ad targeting may be implemented in any context in which advertising is targeted to users based on their interests and the interests of other users connected to the user. Interests of a user may include behavioral characteristics described above. By applying the inferential ad targeting techniques described above on various platforms of information delivery, such as ad-hoc networks, peer-to-peer networks, mobile-to-mobile communications, and other such contexts, advertisers may extend the reach of their advertisements while delivering interesting and informative ads to users based on their interests, inferred or otherwise.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method for targeting advertisements to members of a social network, the method comprising:
receiving a request for an ad to be provided to a member of the social network;
accessing one or more ads, each ad comprising targeting criteria;
for each of the accessed ads, applying the targeting criteria of the ad to profile information for the member in the social network to determine whether the ad is a candidate for targeting to the member;
responsive to determining that the member's profile lacks information for evaluating the targeting criteria, applying the targeting criteria of the ad to profile information for one or more other members of the social network to whom the member is connected, to determine whether the ad is a candidate for targeting to the member;
selecting an ad from the candidate ads determined for the member; and
sending the selected ad to an electronic device associated with the member.

2. The computer-implemented method of claim 1, wherein the request for an ad is a request for a web page containing an ad.

3. The computer-implemented method of claim 1, wherein targeting criteria comprises a first criteria to be applied to the member's profile and a second criteria to be applied to the profiles of the other members connected to the member.

4. The computer-implemented method of claim 3, wherein the first criteria is different than the second criteria.

5. The computer-implemented method of claim 3, wherein the second criteria is a function of affinities between the member and the other members connected to the member.

6. The computer-implemented method of claim 3, wherein the second criteria evaluates a plurality of other members connected to the member and applies a predetermined threshold to the evaluations to determine whether the ad is a candidate for targeting to the member.

7. The computer-implemented method of claim 3, wherein the second criteria is applied to a subset of the profiles of the other members connected to the member, the subset determined based on a test.

8. The computer-implemented method of claim 1, wherein the targeting criteria is a function of a static property in the member's profile.

9. The computer-implemented method of claim 1, wherein the targeting criteria is a function of a dynamic property in the member's profile.

10. The computer-implemented method of claim 1, wherein the targeting criteria is applied to direct connections of the member.

11. The computer-implemented method of claim 1, wherein the targeting criteria is applied to direct and indirect connections of the member.

12. The computer-implemented method of claim 1, wherein selecting an ad for the member is a function of potential revenue, the selected ad maximizing the potential revenue.

13. The computer-implemented method of claim 1, wherein selecting an ad for the member comprises:
for each identified ad of the candidate set of ads:
computing an expected click-through rate (ECTR) weighted by the affinity for the connection, and
computing an expected value for each identified ad; and
selecting the identified ad with the highest expected value.

14. The computer-implemented method of claim 1, wherein selecting an ad for the member comprises:
for each identified ad of the candidate set of ads, each ad having identified connections' profiles that list the particular interest, ranking the ad by the member's affinity for the connections; and
selecting the identified ad with the highest affinity.

15. The computer-implemented method of claim 1, wherein selecting an ad for the member comprises:
for each identified ad of the candidate set of ads, computing an expected click-through rate (ECTR) weighted by the affinity for the connection;
narrowing the candidate set of ads to the identified ads with computed ECTRs that exceed a predetermined threshold;
selecting the identified ad with the highest ECTR.

16. The computer-implemented method of claim 15, further comprising queuing the narrowed candidate set of ads for subsequent presentation.

17. The computer-implemented method of claim 1, wherein selecting an ad for the member comprises:
for each identified ad of the candidate set of ads, computing an expected click-through rate (ECTR) weighted by the affinity for the connection;
narrowing the candidate set of ads to the identified ads with computed ECTRs that exceed a predetermined threshold;
computing an expected value for each identified ad in the narrowed candidate set of ads; and
selecting the identified ad with the highest expected value.

18. The computer-implemented method of claim 17, further comprising queuing the narrowed candidate set of ads for subsequent presentation.

19. The computer-implemented method of claim 1, wherein selecting an ad for the member is a function of affinities between the member and the other members connected to the member, the selected ad having the highest affinity.

20. The computer-implemented method of claim 1, further comprising:
receiving feedback from the member corresponding to the selected ad;
recalculating the member's affinities for the identified connections listing the particular interest;
storing the recalculated affinities in the member's profile.

21. A computer-implemented method for targeting advertisements to members of a social network, the method comprising:
receiving a request for an ad to be provided to a member of the social network;
accessing one or more ads, each ad comprising targeting criteria;
for each of the accessed ads, a step for applying the targeting criteria of the ad to profile information for the member in the social network to determine whether the ad is a candidate for targeting to the member;
responsive to determining that the member's profile lacks information for evaluating the targeting criteria, a step for applying the targeting criteria of the ad to profile information for one or more other members of the social network to whom the member is connected, to determine whether the ad is a candidate for targeting to the member;
a step for selecting an ad from the candidate ads determined for the member; and
sending the selected ad to an electronic device associated with the member.

22. A computer-implemented method for targeting advertisements, the method comprising:
maintaining a plurality of user accounts and a set of connections among the user accounts, wherein one or more of the user accounts includes one or more connections to other user accounts;
receiving a request for an ad to be provided to a user associated with one of the user accounts;
identifying one or more candidate ads to provide to the user, each candidate ad associated with targeting criteria;
for each of the candidate ads, applying the targeting criteria associated with the candidate ad to one or more of the user accounts that have connections to the user account associated with the user;
selecting at least one ad from the candidate ads based at least in part on the applying the targeting criteria associated with the candidate ad to one or more of the user accounts that have connections to the user account associated with the user; and
sending the selected ad to an electronic device associated with the user.

23. The method of claim 22, further comprising:
for each of the candidate ads, applying the targeting criteria associated with the candidate ad to the user account associated with the user;
wherein the selecting at least one ad from the candidate ads is also based on the applying the targeting criteria associated with the candidate ad to the user account associated with the user.

24. The method of claim 22, wherein one or more of the user accounts store static information about a user associated with the user account, and applying the targeting criteria to a user account comprises comparing the targeting criteria against the static information stored in the user account.

25. The method of claim 22, wherein one or more of the user accounts are associated with dynamic information about a user associated with the user account, and applying the targeting criteria to a user account comprises comparing the targeting criteria against the dynamic information associated with the user account.

26. A computerized system for targeting advertisements to members of a social network, the system comprising:
a member profile store containing profiles of members of the social network;
an ad store containing a plurality of ads, each ad comprising targeting criteria;
a communications server for communicating with member devices requesting advertisements; and
an ad server, communicatively coupled to the communications server, the member profile store, and the ad store, for targeting advertisements to the members of the social network using an inferential targeting method, the ad server comprising:
a module for receiving a request for an ad to be provided to a member of the social network;
a module for applying the targeting criteria of one or more of the ads to profile information for the member in the social network to determine whether the ad is a candidate for targeting to the member;
a module for applying, responsive to determining that the member's profile lacks information for evaluating the targeting criteria, the targeting criteria of the ad to profile information for one or more other members of the social network to whom the member is connected, to determine whether the ad is a candidate for targeting to the member; and
a module for selecting an ad from the candidate ads determined for the member

27. The system of claim 26, wherein the targeting criteria comprises a first criteria to be applied to the member's profile and a second criteria to be applied to the profiles of the other members connected to the member.

28. The system of claim 27, wherein the second criteria is a function of affinities between the member and the other members connected to the member.

29. The system of claim 27, wherein the second criteria evaluates a plurality of other members connected to the member and applies a predetermined threshold to the evaluations to determine whether the ad is a candidate for targeting to the member.

30. The system of claim 27, wherein the second criteria applies to a subset of the profiles of the other members connected to the member, the subset determined based on a test.

31. The system of claim 26, wherein the inferential targeting method selects an ad for the member as a function of potential revenue, the selected ad maximizing the potential revenue.

32. The system of claim 26, wherein the inferential targeting method selects an ad for the member as a function of affinities between the member and the other members connected to the member, the selected ad having the highest affinity.

33. The system of claim 26, wherein the communications server is further adapted to receive feedback from the member corresponding to the selected ad, and the ad server is further adapted to recalculate the member's affinities for the identified connections listing the particular interest and store the recalculated affinities in the member's profile in the member profile store.
